(19) United States
(12) Patent Application Publication
(10) Pub. No.: US 2026/0172452 A1
(43) Pub. Date: Jun. 18, 2026

(54) Systems and methods for generating a network policy

(71) Applicant: Sophos Limited, Abingdon (GB)

(72) Inventors: Prashant Gaur, Bangalore (IN); Deepak Tiwari, Delhi (IN); Laxmikant Agarwal, Bangalore (IN); Ashish Aswal, Bangalore (IN); Chandan Kumar Ghosh, West Bengal (IN)

(21) Appl. No.: 18/984,168

(22) Filed: Dec. 17, 2024

(51) Int. Cl. H04L 9/40

(52) U.S. Cl. CPC H04L 63/20; H04L 63/0236

(57) ABSTRACT

Systems and methods for generating a network policy. The method includes receiving at an interface a goal-based rule specifying a network policy that is to be enforced at each of a plurality of enforcement points; communicating the goal-based rule to one or more processors executing instructions stored on memory to provide a rules service; generating a first serialized rule based on the goal-based rule and a first enforcement point of the plurality of enforcement points, wherein the first serialized rule is in a first format interpretable by the first enforcement point; generating a second serialized rule based on the goal-based rule and a second enforcement point of the plurality of enforcement points, wherein the second serialized rule is in a second format interpretable by the second enforcement point. The method further includes enforcing the first serialized rule at the first enforcement point and enforcing the second serialized rule at the second enforcement point.

### TECHNICAL FIELD

The present application relates generally to systems and methods for monitoring network activity and, more particularly but not exclusively, to systems and methods for generating a network policy.

### BACKGROUND

Secure Access Service Edge (SASE) is a cloud computing service to provide security controls at network endpoints or otherwise at edge computing locations. An administrator may use SASE to enforce a particular security policy on their network. This may require the administrator to create multiple rules for each individual device, network, subnet, or the like.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

Embodiments herein provide systems and methods for generating a network policy. A network administrator other interested personnel may provide a goal-based rule that is to be enforced at each of a plurality of enforcement points on a network. A goal-based rule may specify a desired outcome and allow an administrator to create policies or rules to be enforced at multiple enforcement points on the network.

In accordance with the described embodiments, an administrator may only need to specify a single rule, and the embodiments herein enforce the rule at each of a plurality enforcement points. This may involve generating one or more serialized rules based on the goal-based rule and the enforcement point(s). For example, a first serialized rule may be enforced at a first enforcement point, and a second serialized rule may be enforced at a second enforcement point.

### BRIEF DESCRIPTION OF DRAWINGS

Non-limiting and non-exhaustive embodiments of the disclosed subject matter are described with reference to the following figures, wherein like reference numerals refer to like parts throughout the various views unless otherwise specified:

FIG. 1 illustrates a block diagram of a threat management system in accordance with one embodiment;

FIG. 2 illustrates a system for generating a network policy in accordance with one embodiment;

FIG. 3 illustrates the rules service of FIG. 2 in accordance with one embodiment;

FIG. 4 depicts a table listing several rules and associated enforcement points in accordance with one embodiment; and

FIG. 5 depicts a sequence diagram of a method for generating a network policy in accordance with one embodiment.

### DETAILED DESCRIPTION

Various embodiments are described more fully below with reference to the accompanying drawings, which form a part hereof, and which show specific embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

To simplify the generation and enforcement of a network policy, the embodiments herein implement a rules service that defines a network policy that is interpreted differently for different enforcement points. This allows an administrator to create a single network policy in terms of a specified outcome, and the embodiments herein enforce the network policy at each of a plurality of enforcement points.

Network policies often need to be enforced at multiple enforcement points (also referred to as “filtering stages”). These enforcement points may include domain name server (DNS), firewall, transport layer security (TLS), etc. In accordance with the embodiments described herein, a single rule may be enforced across a range of different filtering stages. For example, a network policy to block employees from accessing a particular website may be enforced at the (DNS) stage and at a web uniform resource locator (URL) stage. As another example, a network policy to scan for malware may be enforced at the TLS stage, a web content stage, and an intrusion protection system (IPS) stage.

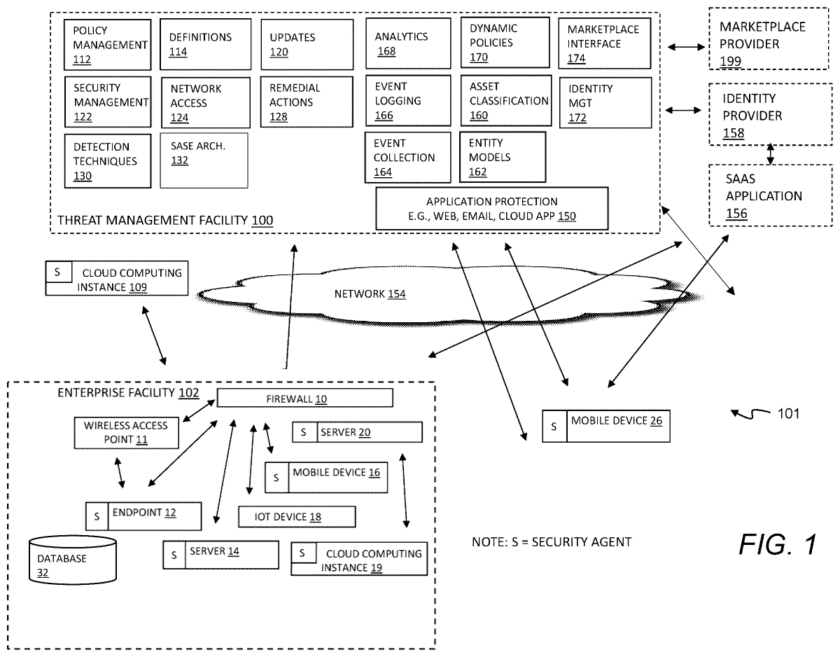

FIG. 1 illustrates a block diagram of a threat management system 101 providing protection against a plurality of threats, such as malware, viruses, spyware, cryptoware, adware, Trojans, spam, intrusion, policy abuse, improper configuration, vulnerabilities, improper access, uncontrolled access, and more. A threat management facility 100 may communicate with, coordinate, and control operation of security functionality at different control points, layers, and levels within the threat management system 101. A number of capabilities may be provided by a threat management facility 100, with an overall goal to intelligently use the breadth and depth of information that is available about the operation and activity of compute instances and networks as well as a variety of available controls. Another overall goal is to provide protection needed by an organization that is dynamic and able to adapt to changes in compute instances and new threats. In embodiments, the threat management facility 100 may provide protection from a variety of threats to a variety of compute instances in a variety of locations and network configurations.

As one example, users of the threat management facility 100 may define and enforce policies that control access to and use of compute instances, networks and data. Administrators may update policies such as by designating authorized users and conditions for use and access. The threat management facility 100 may update and enforce those policies at various levels of control that are available, such as by directing compute instances to control the network traffic that is allowed to traverse firewalls and wireless access points, applications and data available from servers, applications and data permitted to be accessed by endpoints, and network resources and data permitted to be run and used by endpoints. The threat management facility 100 may provide many different services, and policy management may be offered as one of the services.

Turning to a description of certain capabilities and components of the threat management system 101, the enterprise facility 102 may be or may include any networked computer-based infrastructure. For example, the enterprise facility 102 may be corporate, commercial, organizational, educational, governmental, or the like. As home networks become more complicated and include more compute instances at home and in the cloud, an enterprise facility 102 may also or instead include a personal network such as a home or a group of homes. The enterprise facility's 102 computer network may be distributed amongst a plurality of physical premises such as buildings on a campus, and located in one or in a plurality of geographical locations. The configuration of the enterprise facility as shown is by way of example, and it will be understood that there may be any number of compute instances, less or more of each type of compute instances, and other types of compute instances. As shown, the enterprise facility includes a firewall 10, a wireless access point 11, an endpoint 12, a server 14, a mobile device 16, an appliance or Internet-of-Things (IOT) device 18, a cloud computing instance 19, a server 20, a user device, an application load balancer 30, and a network load balancer 34. Again, the compute instances 10-20 depicted are by way of example, and there may be any number or types of compute instances 10-20 in a given enterprise facility. For example, in addition to the elements depicted in the enterprise facility 102, there may be one or more gateways, bridges, wired networks, wireless networks, virtual private networks, other compute instances, and so on.

The threat management facility 100 may include or otherwise be in communication certain facilities, such as a policy management facility 112, security management facility 122, update facility 120, definitions facility 114, network access facility 124, remedial action facility 128, detection techniques facility 130, a Secure Access Service Edge (SASE) architecture 132, a cloud controller 134, application protection 150, asset classification facility 160, entity model facility 162, event collection facility 164, event logging facility 166, analytics facility 168, dynamic policies facility 170, identity management facility 172, and marketplace interface facility 174, a firmware repository 176, a build system 178, as well as other facilities. For example, there may be a testing facility, a threat research facility, and other facilities (not shown). It should be understood that the threat management facility 100 may be implemented in whole or in part on a number of different compute instances, with some parts of the threat management facility on different compute instances in different locations. For example, some or all of one or more of the various facilities 100, 112-174 may be provided as part of a security agent S that is included in software running on a compute instance 10-26 within the enterprise facility 102. Some or all of one or more of the facilities 100, 112-174 may be provided on the same physical hardware or logical resource as a gateway, such as a firewall 10, or wireless access point 11. Some or all of one or more of the facilities 100, 112-174 may be provided on one or more cloud servers that are operated by the enterprise or by a security service provider, such as the cloud computing instance 109.

In embodiments, a marketplace provider 199 may make available one or more additional facilities to the enterprise facility 102 via the threat management facility 100. The marketplace provider 199 may communicate with the threat management facility 100 via the marketplace interface facility 174 to provide additional functionality or capabilities to the threat management facility 100 and compute instances 10-26. As non-limiting examples, the marketplace provider 199 may be a third-party information provider, such as a physical security event provider; the marketplace provider 199 may be a system provider, such as a human resources system provider or a fraud detection system provider; the marketplace provider 199 may be a specialized analytics provider; and so on. The marketplace provider 199, with appropriate permissions and authorization, may receive and send events, observations, inferences, controls, convictions, policy violations, or other information to the threat management facility 100. For example, the marketplace provider 199 may subscribe to and receive certain events, and in response, based on the received events and other events available to the marketplace provider 199, send inferences to the marketplace interface facility 174, and in turn to the analytics facility 168, which in turn may be used by the security management facility 122.

The identity provider 158 may be any remote identity management system or the like configured to communicate with an identity management facility 172, e.g., to confirm identity of a user as well as provide or receive other information about users that may be useful to protect against threats. In general, the identity provider 158 may be any system or entity that creates, maintains, and manages identity information for principals while providing authentication services to relying party applications, e.g., within a federation or distributed network. The identity provider 158 may, for example, offer user authentication as a service, where other applications, such as web applications, outsource the user authentication step(s) to a trusted identity provider.

In embodiments, the identity provider 158 may provide user identity information, such as multi-factor authentication, to a software-as-a-service (SaaS) application. Centralized identity providers such as Microsoft Azure, may be used by an enterprise facility instead of maintaining separate identity information for each application or group of applications, and as a centralized point for integrating multifactor authentication. In embodiments, the identity management facility 172 may communicate hygiene, or security risk information, to the identity provider 158. The identity management facility 172 may determine a risk score for a user based on the events, observations, and inferences about that user and the compute instances associated with the user. If a user is perceived as risky, the identity management facility 172 can inform the identity provider 158, and the identity provider 158 may take steps to address the potential risk, such as to confirm the identity of the user, confirm that the user has approved the SaaS application access, remediate the user's system, or such other steps as may be useful.

In embodiments, threat protection provided by the threat management facility 100 may extend beyond the network boundaries of the enterprise facility 102 to include clients (or client facilities) such as an endpoint 22 or other type of computing device outside the enterprise facility 102, a mobile device 26, a cloud computing instance 109, or any other devices, services or the like that use network connectivity not directly associated with or controlled by the enterprise facility 102, such as a mobile network, a public cloud network, or a wireless network at a hotel or coffee shop or other type of public location. While threats may come from a variety of sources, such as from network threats, physical proximity threats, secondary location threats, the compute instances 10-26 may be protected from threats even when a compute instance 10-26 is not connected to the enterprise facility 102 network, such as when compute instances 22 or 26 use a network that is outside of the enterprise facility 102 and separated from the enterprise facility 102, e.g., by a gateway, a public network, and so forth.

In some implementations, compute instances 10-26 may communicate with cloud applications, such as a SaaS application 156. The SaaS application 156 may be an application that is used by but not operated by the enterprise facility 102. Examples of commercially available SaaS applications 156 include Salesforce, Amazon Web Services (AWS) applications, Google Apps applications, Microsoft Office 365 applications and so on. A given SaaS application 156 may communicate with an identity provider 158 to verify user identity consistent with the requirements of the enterprise facility 102. The compute instances 10-26 may communicate with an unprotected server (not shown) such as a web site or a third-party application through an network 154 such as the Internet or any other public network, private network or combination thereof.

In embodiments, aspects of the threat management facility 100 may be provided as a stand-alone solution. In other embodiments, aspects of the threat management facility 100 may be integrated into a third-party product. An application programming interface (e.g., a source code interface) may be provided such that aspects of the threat management facility 100 may be integrated into or used by or with other applications. For instance, the threat management facility 100 may be stand-alone in that it provides direct threat protection to an enterprise or computer resource, where protection is subscribed to the facility 100. Alternatively, the threat management facility 100 may offer protection indirectly, through a third-party product, where an enterprise may subscribe to services through the third-party product, and threat protection to the enterprise may be provided by the threat management facility 100 through the third-party product.

The security management facility 122 may provide protection from a variety of threats by providing, as non-limiting examples, endpoint security and control, email security and control, web security and control, reputation-based filtering, machine learning classification, control of unauthorized users, control of guest and non-compliant computers, and more.

The security management facility 122 may provide malicious code protection to a compute instance. The security management facility 122 may include functionality to scan applications, files, and data for malicious code, remove or quarantine applications and files, prevent certain actions, perform remedial actions, as well as other security measures. Scanning may use any of a variety of techniques, including without limitation signatures, identities, classifiers, and other suitable scanning techniques. In embodiments, the scanning may include scanning some or all files on a periodic basis, scanning an application when the application is executed, scanning data transmitted to or from a device, scanning in response to predetermined actions or combinations of actions, and so forth. The scanning of applications, files, and data may be performed to detect known or unknown malicious code or unwanted applications. Aspects of the malicious code protection may be provided, for example, in a security agent of an endpoint 12, in a wireless access point 11 or firewall 10, as part of application protection 150 provided by the cloud, and so on.

In an embodiment, the security management facility 122 may provide for email security and control, for example to target spam, viruses, spyware and phishing, to control email content, and the like. Email security and control may protect against inbound and outbound threats, protect email infrastructure, prevent data leakage, provide spam filtering, and more. Aspects of the email security and control may be provided, for example, in the security agent of an endpoint 12, in a wireless access point 11 or firewall 10, as part of application protection 150 provided by the cloud, and so on.

In an embodiment, security management facility 122 may provide for web security and control, for example, to detect or block viruses, spyware, malware, or unwanted applications; help control web browsing; and the like, which may provide comprehensive web access control to enable safe and productive web browsing. Web security and control may provide Internet use policies, reporting on suspect compute instances, security and content filtering, active monitoring of network traffic, Uniform Resource Identifier (URI) filtering, and the like. Aspects of the web security and control may be provided, for example, in the security agent of an endpoint 12, in a wireless access point 11 or firewall 10, as part of application protection 150 provided by the cloud, and so on.

In an embodiment, the security management facility 122 may provide for network access control, which generally controls access to and use of network connections. Network control may stop unauthorized, guest, or non-compliant systems from accessing networks, and may control network traffic that is not otherwise controlled at the client level. In addition, network access control may control access to virtual private networks (VPN), where VPNs may, for example, include communications networks tunneled through other networks and establishing logical connections acting as virtual networks. In embodiments, a VPN may be treated in the same manner as a physical network. Aspects of network access control may be provided, for example, in the security agent of an endpoint 12, in a wireless access point 11 or firewall 10, as part of application protection 150 provided by the cloud, e.g., from the threat management facility 100 or other network resource(s).

In an embodiment, the security management facility 122 may provide for host intrusion prevention through behavioral monitoring and/or runtime monitoring, which may guard against unknown threats by analyzing application behavior before or as an application runs. This may include monitoring code behavior, application programming interface calls made to libraries or to the operating system, or otherwise monitoring application activities. Monitored activities may include, for example, reading and writing to memory, reading and writing to disk, network communication, process interaction, and so on. Behavior and runtime monitoring may intervene if code is deemed to be acting in a manner that is suspicious or malicious. Aspects of behavior and runtime monitoring may be provided, for example, in the security agent of an endpoint 12, in a wireless access point 11 or firewall 10, as part of application protection 150 provided by the cloud, and so on.

In an embodiment, the security management facility 122 may provide for reputation filtering, which may target or identify sources of known malware. For instance, reputation filtering may include lists of URIs of known sources of malware or known suspicious IP addresses, code authors, code signers, or domains, that when detected may invoke an action by the threat management facility 100. Based on reputation, potential threat sources may be blocked, quarantined, restricted, monitored, or some combination of these, before an exchange of data can be made. Aspects of reputation filtering may be provided, for example, in the security agent of an endpoint 12, in a wireless access point 11 or firewall 10, as part of application protection 150 provided by the cloud, and so on. In embodiments, some reputation information may be stored on a compute instance 10-26, and other reputation data available through cloud lookups to an application protection lookup database, such as may be provided by application protection 150.

In embodiments, information may be sent from the enterprise facility 102 to a third party, such as a security vendor, or the like, which may lead to improved performance of the threat management facility 100. In general, feedback may be useful for any aspect of threat detection. For example, the types, times, and number of virus interactions that an enterprise facility 102 experiences may provide useful information for the preventions of future virus threats. Feedback may also be associated with behaviors of individuals within the enterprise, such as being associated with most common violations of policy, network access, unauthorized application loading, unauthorized external device use, and the like. In embodiments, feedback may enable the evaluation or profiling of client actions that are violations of policy that may provide a predictive model for the improvement of enterprise policies.

An update facility 120 may provide control over when updates are performed. The updates may be automatically transmitted, manually transmitted, or some combination of these. Updates may include software, definitions, reputations or other code or data that may be useful to the various facilities. For example, the update facility 120 may manage receiving updates from a provider, distribution of updates to enterprise facility 102 networks and compute instances, or the like. In embodiments, updates may be provided to the enterprise facility's 102 network, where one or more compute instances on the enterprise facility's 102 network may distribute updates to other compute instances.

The threat management facility 100 may include a policy management facility 112 that manages rules or policies for the enterprise facility 102. Examples of rules include access permissions associated with networks, applications, compute instances, users, content, data, and the like. The policy management facility 112 may use a database, a text file, other data store, or a combination to store policies. In an embodiment, a policy database may include a block list, a black list, an allowed list, a white list, and more. As a few non-limiting examples, policies may include a list of enterprise facility 102 external network locations/applications that may or may not be accessed by compute instances, a list of types/classifications of network locations or applications that may or may not be accessed by compute instances, and contextual rules to evaluate whether the lists apply. For example, there may be a rule that does not permit access to sporting websites. When a website is requested by the client facility, a security management facility 122 may access the rules within a policy facility to determine if the requested access is related to a sporting website.

The policy management facility 112 may include access rules and policies that are distributed to maintain control of access by the compute instances 10-26 to network resources. These policies may be defined for an enterprise facility, application type, subset of application capabilities, organization hierarchy, compute instance type, user type, network location, time of day, connection type, or any other suitable definition. Policies may be maintained through the threat management facility 100, in association with a third party, or the like. For example, a policy may restrict instant messaging (IM) activity by limiting such activity to support personnel when communicating with customers. More generally, this may allow communication for departments as necessary or helpful for department functions, but may otherwise preserve network bandwidth for other activities by restricting the use of IM to personnel that need access for a specific purpose. In an embodiment, the policy management facility 112 may be a stand-alone application, may be part of the network server facility 142, may be part of the enterprise facility 102 network, may be part of the client facility, or any suitable combination of these.

The policy management facility 112 may include dynamic policies that use contextual or other information to make security decisions. As described herein, the dynamic policies facility 170 may generate policies dynamically based on observations and inferences made by the analytics facility. The dynamic policies generated by the dynamic policy facility 170 may be provided by the policy management facility 112 to the security management facility 122 for enforcement.

In embodiments, the threat management facility 100 may provide configuration management as an aspect of the policy management facility 112, the security management facility 122, or some combination. Configuration management may define acceptable or required configurations for the compute instances 10-26, applications, operating systems, hardware, or other assets, and manage changes to these configurations. Assessment of a configuration may be made against standard configuration policies, detection of configuration changes, remediation of improper configurations, application of new configurations, and so on. An enterprise facility may have a set of standard configuration rules and policies for particular compute instances which may represent a desired state of the compute instance. For example, on a given compute instance 12, 14, 18, a version of a client firewall may be required to be running and installed. If the required version is installed but in a disabled state, the policy violation may prevent access to data or network resources. A remediation may be to enable the firewall. In another example, a configuration policy may disallow the use of Universal Serial Bus (USB) disks, and the policy management facility 112 may require a configuration that turns off USB drive access via a registry key of a compute instance. Aspects of configuration management may be provided, for example, in the security agent of an endpoint 12, in a wireless access point 11 or firewall 10, as part of application protection 150 provided by the cloud, or any combination of these.

In embodiments, the threat management facility 100 may also provide for the isolation or removal of certain applications that are not desired or may interfere with the operation of a compute instance 10-26 or the threat management facility 100, even if such application is not malware per se. The operation of such products may be considered a configuration violation. The removal of such products may be initiated automatically whenever such products are detected, or access.

The policy management facility 112 may also require update management (e.g., as provided by the update facility 120). Update management for the security management facility 122 and policy management facility 112 may be provided directly by the threat management facility 100, or, for example, by a hosted system. In embodiments, the threat management facility 100 may also provide for patch management, where a patch may be an update to an operating system, an application, a system tool, or the like, where one of the reasons for the patch is to reduce vulnerability to threats.

In embodiments, the security management facility 122 and policy management facility 112 may push information to the enterprise facility 102 network and/or the compute instances 10-26, the enterprise facility 102 network and/or compute instances 10-26 may pull information from the security management facility 122 and policy management facility 112, or there may be a combination of pushing and pulling of information. For example, the enterprise facility 102 network and/or compute instances 10-26 may pull update information from the security management facility 122 and policy management facility 112 via the update facility 120, an update request may be based on a time period, by a certain time, by a date, on demand, or the like. In another example, the security management facility 122 and policy management facility 112 may push the information to the enterprise facility's 102 network and/or compute instances 10-26 by providing notification that there are updates available for download and/or transmitting the information. In an embodiment, the policy management facility 112 and the security management facility 122 may work in concert with the update facility 120 to provide information to the enterprise facility's 102 network and/or compute instances 10-26. In various embodiments, policy updates, security updates and other updates may be provided by the same or different modules, which may be the same or separate from a security agent running on one of the compute instances 10-26.

As threats are identified and characterized, the definition facility 114 of the threat management facility 100 may manage definitions used to detect and remediate threats. For example, identity definitions may be used for scanning files, applications, data streams, etc. for the determination of malicious code. Identity definitions may include instructions and data that can be parsed and acted upon for recognizing features of known or potentially malicious code. Definitions also may include, for example, code or data to be used in a classifier, such as a neural network or other classifier that may be trained using machine learning. Updated code or data may be used by the classifier to classify threats. In embodiments, the threat management facility 100 and the compute instances 10-26 may be provided with new definitions periodically to include most recent threats. Updating of definitions may be managed by the update facility 120, and may be performed upon request from one of the compute instances 10-26, upon a push, or some combination. Updates may be performed upon a time period, on demand from a device 10-26, upon determination of an important new definition or a number of definitions, and so on.

A threat research facility (not shown) may provide a continuously ongoing effort to maintain the threat protection capabilities of the threat management facility 100 in light of continuous generation of new or evolved forms of malware. Threat research may be provided by researchers and analysts working on known threats, in the form of policies, definitions, remedial actions, and so on.

The security management facility 122 may scan an outgoing file and verify that the outgoing file is permitted to be transmitted according to policies. By checking outgoing files, the security management facility 122 may be able discover threats that were not detected on one of the compute instances 10-26, or policy violation, such transmittal of information that should not be communicated unencrypted.

The threat management facility 100 may control access to the enterprise facility 102 networks. A network access facility 124 may restrict access to certain applications, networks, files, printers, servers, databases, and so on. In addition, the network access facility 124 may restrict user access under certain conditions, such as the user's location, usage history, need to know, job position, connection type, time of day, method of authentication, client-system configuration, or the like. Network access policies may be provided by the policy management facility 112, and may be developed by the enterprise facility 102, or pre-packaged by a supplier. Network access facility 124 may determine if a given compute instance 10-22 should be granted access to a requested network location, e.g., inside or outside of the enterprise facility 102. Network access facility 124 may determine if a compute instance 22, 26 such as a device outside the enterprise facility 102 may access the enterprise facility 102. For example, in some cases, the policies may require that when certain policy violations are detected, certain network access is denied. The network access facility 124 may communicate remedial actions that are necessary or helpful to bring a device back into compliance with policy as described below with respect to the remedial action facility 128. Aspects of the network access facility 124 may be provided, for example, in the security agent of the endpoint 12, in a wireless access point 11, in a firewall 10, as part of application protection 150 provided by the cloud, and so on.

In an embodiment, the network access facility 124 may have access to policies that include one or more of a block list, a black list, an allowed list, a white list, an unacceptable network site database, an acceptable network site database, a network site reputation database, or the like of network access locations that may or may not be accessed by the client facility. Additionally, the network access facility 124 may use rule evaluation to parse network access requests and apply policies. The network access facility 124 may have a generic set of policies for all compute instances, such as denying access to certain types of websites, controlling instant messenger accesses, or the like. Rule evaluation may include regular expression rule evaluation, or other rule evaluation method(s) for interpreting the network access request and comparing the interpretation to established rules for network access. Classifiers may be used, such as neural network classifiers or other classifiers that may be trained by machine learning.

The threat management facility 100 may include an asset classification facility 160. The asset classification facility will discover the assets present in the enterprise facility 102. A compute instance such as any of the compute instances 10-26 described herein may be characterized as a stack of assets. The one level asset is an item of physical hardware. The compute instance may be, or may be implemented on physical hardware, and may have or may not have a hypervisor, or may be an asset managed by a hypervisor. The compute instance may have an operating system (e.g., Windows, macOS, OS X, Linux, Android, iOS). The compute instance may have one or more layers of containers. The compute instance may have one or more applications, which may be native applications, e.g., for a physical asset or virtual machine, or running in containers within a computing environment on a physical asset or virtual machine, and those applications may link libraries or other code or the like, e.g., for a user interface, cryptography, communications, device drivers, mathematical or analytical functions and so forth. The stack may also interact with data. The stack may also or instead interact with users, and so users may be considered assets.

The threat management facility 100 may include the entity model facility 162. The entity models may be used, for example, to determine the events that are generated by assets. For example, some operating systems may provide useful information for detecting or identifying events. For examples, operating systems may provide process and usage information that accessed through an application programming interface (API). As another example, it may be possible to instrument certain containers to monitor the activity of applications running on them. As another example, entity models for users may define roles, groups, permitted activities and other attributes.

The event collection facility 164 may be used to collect events from any of a wide variety of sensors that may provide relevant events from an asset, such as sensors on any of the compute instances 10-26, the application protection 150, a cloud computing instance 109 and so on. The events that may be collected may be determined by the entity models. There may be a variety of events collected. Events may include, for example, events generated by the enterprise facility 102 or the compute instances 10-26, such as by monitoring streaming data through a gateway such as firewall 10 and wireless access point 11, monitoring activity of compute instances, monitoring stored files/data on the compute instances 10-26 such as desktop computers, laptop computers, other mobile computing devices, and cloud computing instances 19, 109. Events may range in granularity. One example of an event is the communication of a specific packet over the network. Another example of an event may be identification of an application that is communicating over a network.

The event logging facility 166 may be used to store events collected by the event collection facility 164. The event logging facility 166 may store collected events so that they can be accessed and analyzed by the analytics facility 168. Some events may be collected locally, and some events may be communicated to an event store in a central location or cloud facility. Events may be logged in any suitable format.

Events collected by the event logging facility 166 may be used by the analytics facility 168 to make inferences and observations about the events. These observations and inferences may be used as part of policies enforced by the security management facility Observations or inferences about events may also be logged by the event logging facility 166.

When a threat or other policy violation is detected by the security management facility 122, the remedial action facility 128 may remediate the threat. Remedial action may take a variety of forms, non-limiting examples including collecting additional data about the threat, terminating or modifying an ongoing process or interaction, sending a warning to a user or administrator, downloading a data file with commands, definitions, instructions, or the like to remediate the threat, requesting additional information from the requesting device, such as the application that initiated the activity of interest, executing a program or application to remediate against a threat or violation, increasing telemetry or recording interactions for subsequent evaluation, (continuing to) block requests to a particular network location or locations, scanning a requesting application or device, quarantine of a requesting application or the device, isolation of the requesting application or the device, deployment of a sandbox, blocking access to resources, e.g., a USB port, or other remedial actions. More generally, the remedial action facility 128 may take any steps or deploy any measures suitable for addressing a detection of a threat, potential threat, policy violation or other event, code or activity that might compromise security of a computing instance 10-26 or the enterprise facility 102.

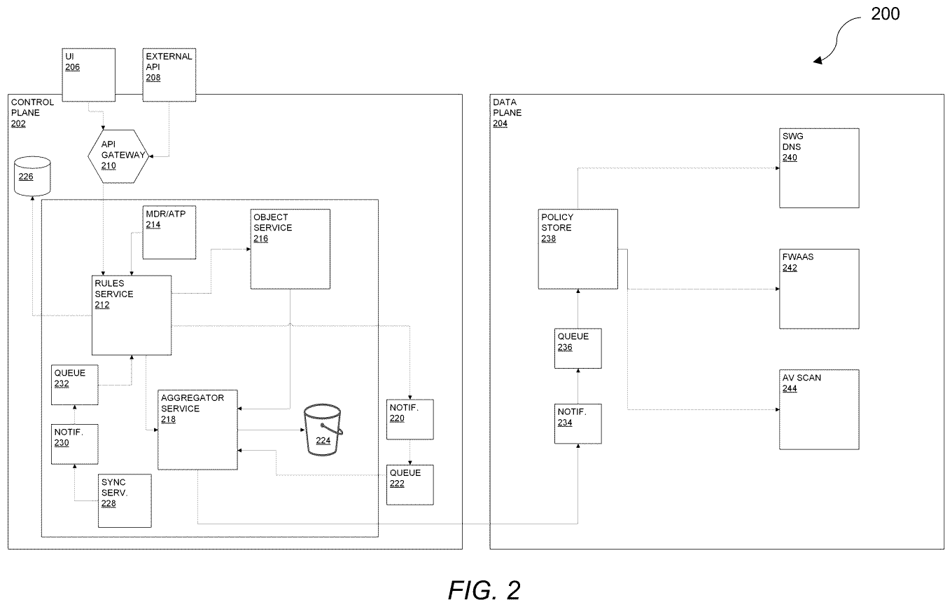

FIG. 2 illustrates a system 200 for generating a network in policy in accordance with one embodiment. The system 200 may execute on a control plane 202 that is associated with a particular region and in communication with a data plane 204. The control plane 202 and the data plane 204 may be part of the SASE architecture 132 of FIG. 1, for example. In operation an administrator may access a user interface (UI) 206 or an external application programming interface (API) 208. For example, a user may be an enterprise network administrator tasked with generating one or more network policies.

The UI 206 or the external API 208 may communicate data such as instructions regarding one or more rules and associated data to an API gateway 210. In some embodiments, the API gateway 210 may be an APIGEE® API Gateway offered by Amazon. com, Inc. headquartered in Seattle, Washington. However, other services whether available now or invented hereafter may be implemented as long as the features of the various embodiments described herein may be accomplished.

The API gateway 210 may forward data pertaining to a rule to a rules service 212 executing in the control plane 202. The rules service 212 may be in further communication with a Managed Detection and Response/Advanced Threat Protection (MDR/ATP) service 214, an object service 216, and an aggregator service 218. The rules service 212 may also provide updates regarding to the rules service 212, wherein these updates are first sent to a notification service 220 before being queued by a queue service 222, before reaching the aggregator service 218.

The MDR/AT service 214 may be a Security Service Edge (SSE) service that creates objects for default policies. In some embodiments, the MDR/AT service 214 may create default rules, such as rules associated with high levels of security (e.g., by treating all network destinations as high-risk destinations).

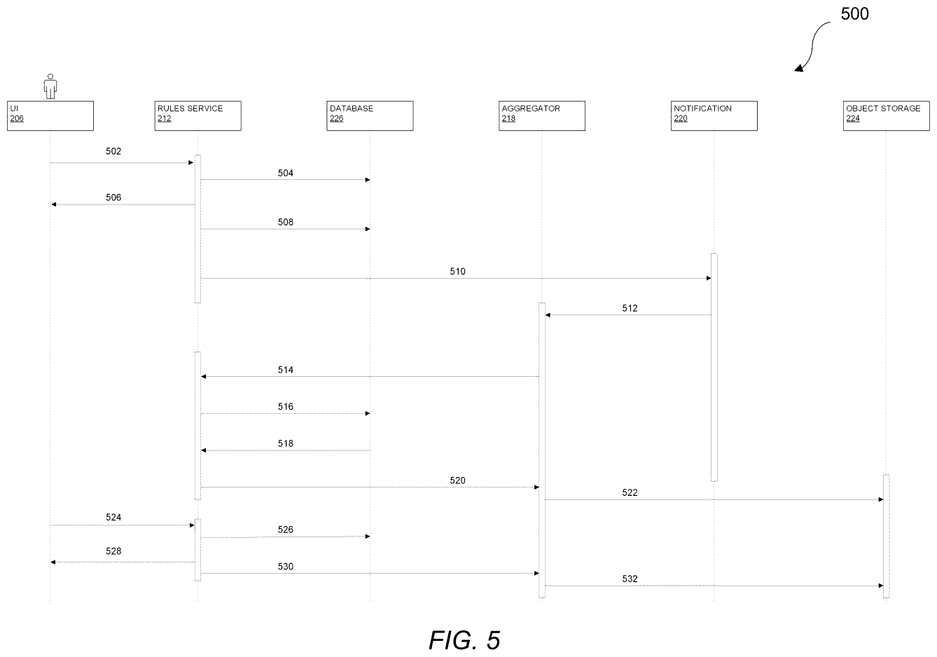

The object service 216 may create and store object primitives. Object primitives are discussed below in conjunction with FIG. 5, and may refer to how objects are structured. The objects service 216 may provide these object primitives to the aggregator service 218 for creating policy bundles that are subsequently enforced in the data plane 204.

The aggregator service 218 may compile policy bundles and store the bundles to a cloud object storage 224. For example, the cloud object storage 224 may refer to cloud storage devices such the AMAZON S3® storage devices by Amazon.com, Inc. The aggregator service 218 may compile these policy bundles based on serialized rules obtained from the rules service 212 and based on object contents obtained from the object service 216. The system 200 may also include one or more databases 226 for storing data regarding generated rules.

A synchronization service 228 may also communicate notifications to a notification service 230 and queue service 232 before the communications reach the rules service 212. The synchronization service 228 may provide updates to the rules service 212 regarding any new entities associated with the system 200 and to create default rules therefor. For example, in some embodiments, the synchronization service 228 may provide updates regarding new tenants that are onboarded on the system 200.

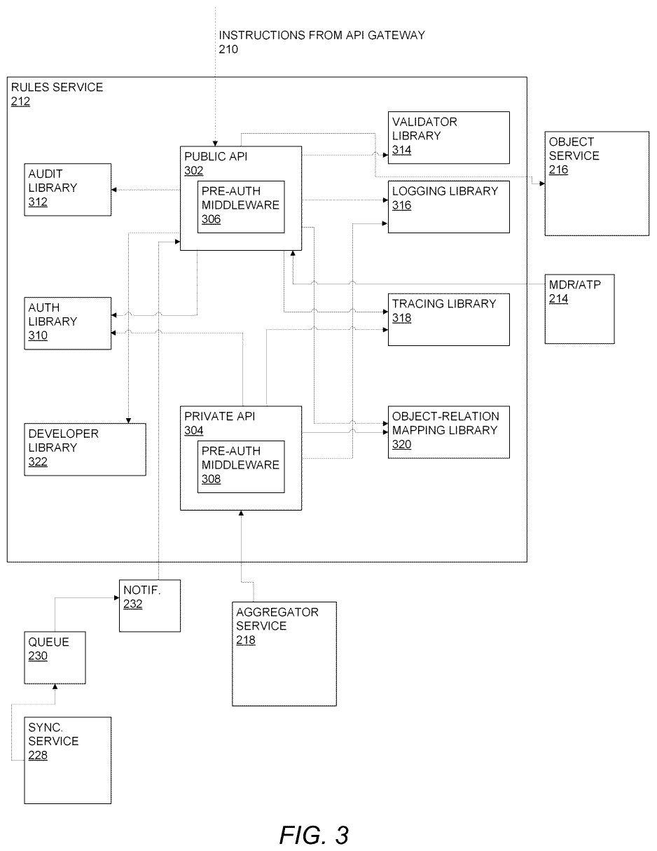

FIG. 3 illustrates the rules service 212 of FIG. 2 in accordance with one embodiment. The rules service 212 may include a public representational state transfer (REST) API server 302 (for simplicity, “public API 302”), a private REST API server 304 (for simplicity, “private API 304”), and pre-authorization middleware 306, 308 associated with the public API 302 and private API 304, respectively. The rules service 212 may further include an authorization library 310, audit library 312, validator library 314, logging library 316, tracing library 318, object-relation mapping library 320, and developer library 322.

The pre-authorization middleware 306 and 308 may perform any required authorization procedures before or during rule generation, updating, deleting, etc. The private API 304 may interact with service-to-service APIs to reference objects, including object primitives. Additionally the private API server 304 may be in communication with the rules service 216 and aggregator service 218 of FIG. 2, which may provide the private API 304 with serialized object contents.

The public API 302 may be in communication with the validator library 314 for performing any appropriate request payload validation. For example, the described embodiments may perform a syntactical validation procedure and a semantical validation procedure on received rules or associated data. In some embodiments, the validator library 314 may use the YANG modeling software. The public API 302 also receive instructions from the API Gateway 210 to allow a user to create, delete, update, or retrieve rules.

The authorization library 310 may authorize requests from the API gateway 210. Specifically, the public API 302 and the private API 304 may each use the authorization library 310 to provide authorization for generating or otherwise configuring network policies. For example, in some embodiments, the APIs 302 and 304 may use the authorization library 310 for token-based authorization to authenticate an administrator before the administrator can create, update, or delete rules.

The audit library 312 may communicate any actions performed by the administrator to the database 226 or the event collection facility 164 of FIG. 1. These actions may include, but are not limited to create, read, update, and delete (“CRUD”) operations associated with rules.

Similarly, the logging library 316 may log all transactions and communications generated by the rules service 212. The logging library 316 may be in further communication with a viewing tool (not shown in FIG. 3) to allow an interested party to view and troubleshoot error logs.

The tracing library 318 may be a third party-provided library tasked with tracing data transactions between services. In some embodiments, the tracing library 318 may be an Open Telemetry software development kit (SDK). The tracing library 318 may be in further communication with any suitable software-as-a-service (SaaS) logging platform. The tracing library 318 may communicate for storage in the database 226 telemetry data such as CPU usage, memory usage, network traffic sent, network traffic received, etc.

Additionally, the tracing library 318 may be used for service level and service-to-service level tracing. The associated telemetry data may be presented to a user via any suitable visualization tool.

The object-relation mapping library 320 may manage communications associated with the database 226. Specifically, the object-relation mapping library 320 may automate operations associated with the database 226, managing records associated such as creating, referencing, updating, and deleting rules.

The public API 302 and private API 304 may leverage the developer library 322 for generating notification events pertaining to rules. The developer library 322 may be in communication with the notification and queue services 220 and 222, respectively, of FIG. 2.

In some embodiments, the rules service 212 may include separate APIs for each type of rule. Similarly, although only one database 226 is illustrated in FIG. 2, some embodiments may have separate database structures such as tables for each type of rule.

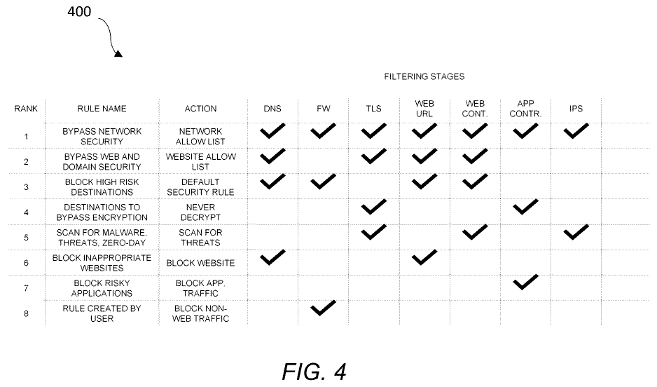

FIG. 4 depicts a table 400 listing several rules and associated enforcement points. A user may assign a name to a rule (“rule name”) along with an action associated with the rule. Rule names and their associated actions may also refer to default rules (i.e., rules that are not created by a user). In some embodiments, the MDR/ATP service 214 may create default rules.

An administrator may also assign a ranking value to each rule. Rankings may determine which rule(s) take priority if two or more rules conflict with each other. In some embodiments, the rankings may be automatically assigned to a rule or, similarly, rules may have default rankings.

The table 400 also lists various filtering stages. These stages include, but are not limited to, DNS, FW, TLS, Web URL, Web Content, Application Control, and IPS. The checkmarks indicate which filtering stages are relevant for a particular rule, and are therefore enforcement points. For example, the “BLOCK INAPPROPRIATE WEBSITES” is enforceable at the DNS stage and the Web URL stage. As another example, the “BLOCK HIGH RISK DESTINATIONS” rule will be enforceable at the DNS, FW, Web URL, and Web content filtering stages.

A table such as the table 400 may be presented to the user via the user interface 206. The table 400 may also include some indicia (e.g., radio buttons, toggle bars, check boxes, etc.) that is engageable by a user to allow the user to activate or deactivate the rules.

FIG. 5 depicts a sequence diagram 500 of a method for generating a network policy in accordance with one embodiment. The method of diagram 500 may involve components described in conjunction with FIGS. 2 and 3, such as the UI 206, the rules service 212, aggregator service 218, notification service 220, and database 226.

A user may provide 502 via the UI 206 an instruction regarding the creation or updating of a rule. The user may refer to an administrator or an external API user, for example. The user may have access to a dashboard or menu such as the table 400 of FIG. 4 that allows the user to, create, update, delete, or view rules, and include rule data such as which enforcement points are applicable for each type of rule. For example, the user may provide an instruction to create a rule that blocks employees from accessing high risk destinations, such as websites that are known to be associated with malware.

The instruction may first be communicated to the public API server 302 of FIG. 3. Data regarding the instruction may be communicated to the various components of the rules service 212, such as the validator library 314, the logging library 316, the tracing library 318, etc. The rules service 212 may store 504 the rule in the database 226, and communicate 506 a response to the UI 206 informing the user that the instructions have been received.

The rules service 212 may then serialize 508 the received rule with a common JavaScript Object Notation (JSON) schema. The rules service 212 is responsible for exposing internal APIs, such as the APIs 302 and 304, and for retrieving rules information in a serialized format. The serialized format may be a REGO-compatible JSON string, which is understood by services in the data plane 204 for enforcement.

In the context of the present application, the serialization of the rule data may refer to the process of structuring a rule based on a primitive form (“primitive”) into a format that can be digested by enforcement points. The rule data may include data such as the name of a rule, the ranking of a rule, the enforcement points to which the rule is applicable, the type of rule, or the like.

The objects service 216 of FIG. 2 (not shown in FIG. 5) may store object data such as object primitives. The rule data of a rule will include the object primitives associated with the objects that are referenced in the rule. For example, if a network object with a Universally Unique Identifier (UUID): 6a31e4e6-2cce-11ee-be56-0242ac120002 is referenced in a rule, its object primitive may be structured as:
{
“op”: “inSet”,
“setOp”: “eq”,
“l”: {“val”: [“src”, ipv4”], “inputPath”: true},
“r”: {“val”: [“6a31e4e6-2cce-llee-be56-0242ac12002”, “ipv4”],
“commonObjPath”: true}
},
{
“op”: “inSet”,
“setOp”: “cidr”,
“l”: {“val”: [“src”, “ipv4”], “inputPath”: true},
“r”: {“val”: [“6a31e4e6-2cce-11ee-be56-0242ac120002”, “subnet”],
“commonObjPath”: true}
},
{
“op”: “ipv4Range”,
“l”: {“val”: [“src”, “ipv4”], “inputPath”: true},
“r”: {“val”: [“6a31e4e6-2cce-11ee-be56-0242ac120002”, “range”],
“commonObjPath”: true}
}
where each content-type above is matched against the input field, e.g., IP address, subnet, and range. The above serialized data is specific for a network object type. Object primitives for other types of objects may include similar or different types of serialized data.

The rules service 212 may serialize the rule data as part of the rule creation and/or updating, and store the serialized rule data for each filtering stage in the database 226. The rules service 212 may create a copy of the rule data for each applicable enforcement point, along with some additional or default parameters that are relevant to each applicable enforcement point. The database 226 may store a separate data structure such a separate table for each enforcement point and rule.

The rules service 212 may communicate 510 data regarding the rule to the notification service 220. This data may include a UUID such as a Tenant identification or other type of identifier, topic of the rule, or any other type of data regarding the rule.

The notification service 220 may then publish 512 the updates regarding the rule (e.g., the creation of a rule) to the aggregator service 218. Although not shown in FIG. 5, the updates may first be queued in the queue service 222 of FIG. 2 before being published to the aggregator service 218.

The aggregator service 218 may issue a request 514 to the rules service 212 to obtain the serialized rule. The request may include an authorization token such as an Secure Service Access v2 token, an identifier such as a tenant ID or other type of identifier, or any other type of data used to identify the desired rule.

The rules service 212 can then request 516 the serialized rule from the database 226, and receive 518 the serialized rule from the database 226. The received data may be in the form of:
{
“rule-id”: “uuid”,
“updatedAt”: <timestamp>,
“checksum”: <md5: checksum string>,
“filtering-stages”: [“DNS”, “FW”]
“objects”: [“uuid-1”, “uuid-2”, “uuid-3”, “uuid-4”],
“rule-body”: <string: serialized json rule body>
}

For example, for a rule with UUID: 7f586180-9cf6-4ecf-82b3-310ed97969e0, the response may be structured as
{
“id”:“7f586180-9cf6-4ecf-82b3-310ed97969e0”,
“checksum”:“md5: flattened content hash”,
“updatedAt”:“<timestamp>”,
“rule-status”:“enabled∥disabled”,
“objects”: [“uuid-1”,“uuid-2”,“uuid-3”],
“seralized-rule”: {
“webContent”: “string: serialized rule payload”,
//Serialized data for the web filtering stage
“tls”: “string: serialised rule payload”
//Serialized rule data for the TLS filtering stage
}

As seen above, this particular rule is applicable at the Web Content filtering stage and the TLS filtering stage. Accordingly, these are the enforcement points for this particular rule.

For this above example, the rules service 212 may maintain two copies of the serialized data. One copy would be applicable to the TLS filtering stage, and the other applicable to the Web Content filtering stage.

In the context of the present application, rules may be “access-based” or “control-based.” In the context of the present application, “access-based” rules define an action and may have values such as allow, block, drop, or reject. Examples of access-based rules may be to block users from accessing a website, allow users to access a website, block high-risk destinations, etc.

In the context of the present application, “control-based” rules define a control action and may have values such as scanning, decrypting, executing an intrusion detection system (IDS), etc. Examples of control-based rules may be to block a particular file type, to not scan certain content, to scan certain content, etc.

”), The rules service 212 may then provide 520 the above data to the aggregator service 216. The aggregator service 216 compiles 522 policy bundles based on the serialized rules from the rules service 212 and based on the object contents received from the object service 214 (not shown in FIG. 5). Referring back to FIGS. 2 and 3, the aggregator service 216 is a consumer to the APIs of the rules service 212, and obtains the serialized rules therefrom for the different enforcement points in the data plane 204. The aggregator service 216 may create policy bundles for each filtering stage. The aggregator service 216 may store these bundles in a cloud object storage 224 such as a bucket as discussed previously, wherein each bucket is specific to an enforcement point.

Administrators may also need to delete a rule such that the rule is not enforced. FIG. 5 illustrates the UI 206 communicating a request 524 to the rules service 212 to delete a rule, and the rules service 212 may then remove 526 the rule from the database 226. The rules service 212 may provide 528 an acknowledgement to the UI 206 that the rule has been deleted.

Additionally, the rules service 212 may communicate 530 a notification to the aggregator service 218 regarding the update. Specifically, the communication may identify the relevant rule by a UUID, and indicate there has been a deletion operation. The aggregator service 218 may then compile 532 the new or otherwise updated policy bundle for transmittal to the cloud object storage 224.

Referring back to FIG. 2, the policy bundles are communicated to the data plane 204 for enforcement. The data plane 204 may also include a notification service 234 and queue service 236. Accordingly, the received policy bundles or updates regarding the policy bundles may be queued in the queue service 236 before reaching the policy store 238.

The policy store 238 may be tasked with communicating the created bundles or rules associated therewith to the applicable enforcement points for enforcement. For example, the policy store 238 may be in communication with a secure web gateway domain name service (“SWG DNS”) 240, a firewall-as-a-service (“FWAAS”) 244, and anti-virus scanning module (“AV Scan”) 246 that act as enforcement points. The SWG DNS 240 may enforce rules at the DNS filtering stage, the FWAAS 244 may enforce rules at the firewall filtering stage, and the AV scanning module 246 may enforce rules at the IPS filtering stage. Although only three enforcement points are shown in FIG. 2, other enforcement points may be used and may depend on the rule.

The disclosed embodiments provide novel features and methods for generating a network policy. Specifically, the embodiments herein reduce the effort required to create network policies such as firewall rules.

The embodiments herein enable a single input (i.e., a single, goal-based rule) to be enforced at multiple enforcement points. As described previously, these enforcement points may be referred to as filtering stages and may include DNS, IPS, firewall, etc.

This is opposed to existing techniques, which require that an administrator be considerably technically versed and knowledgeable. For example, to configure a firewall in accordance with existing techniques, an administrator would need to know where a policy is to be enforced and how the policy will be enforced. The administrator will then need to create multiple rules for each filtering stage to achieve the desired outcome.

An administrator also would have to, in accordance with existing techniques, define multiple match criteria for each filtering stage. This requires an administrator to be knowledgeable regarding each filtering stage, as well as relevant matching criteria for each filtering stage. These existing techniques are also subject to human error, as an administrator may configure a filtering stage that is not relevant for a particular rule.

The embodiments herein reduce the time and complexity to configure enforcement points for a single rule. This in turn preserves computing resources. For example, the embodiments herein more accurately configure filtering stages based on the applicable rule. Resources are therefore not wasted by configuring a filtering stage that ultimately is not relevant for a particular rule.

According to one aspect, embodiments relate to a method for generating a network policy. The method includes receiving at an interface a goal-based rule specifying a network policy that is to be enforced at each of a plurality of enforcement points; communicating the goal-based rule to one or more processors executing instructions stored on memory to provide a rules service; generating a first serialized rule based on the goal-based rule and a first enforcement point of the plurality of enforcement points, wherein the first serialized rule is in a first format interpretable by the first enforcement point; generating a second serialized rule based on the goal-based rule and a second enforcement point of the plurality of enforcement points, wherein the second serialized rule is in a second format interpretable by the second enforcement point; enforcing the first serialized rule at the first enforcement point; and enforcing the second serialized rule at the second enforcement point.

In some embodiments, the plurality of enforcement points include at least one of Domain Name Service (DNS) filtering stage, a firewall, or a Transport Layer Security (TLS) filtering stage, intrusion detection system (IDS) intrusion protection system (IPS), IDS, or web filtering.

In some embodiments, the goal-based rule includes a rank specifying its priority with respect to at least one other goal-based rule.

In some embodiments, generating the goal-based rule into the first serialized rule includes in the first format includes executing a public application programming interface (API) to receive data regarding the goal-based rule, performing a semantic validation step and a syntactic validation step on the data regarding the goal-based rule, and executing a private API to communicate the first serialized rule to a policy aggregation service to enforce the first serialized rule at the first enforcement point.

In some embodiments, the first format interpretable by the first enforcement point is a REGO JavaScript Object Notation (JSON) string.

In some embodiments, the method further includes providing the first serialized rule to a cloud object storage location associated with the plurality of enforcement points, providing the second serialized rule to the cloud object storage location; and communicating the first serialized rule and the second serialized rule from the cloud object storage location to a policy distribution service to distribute the first serialized rule to the first enforcement point and distribute the second serialized rule to the second enforcement point. In some embodiments, the method further includes communicating a notification to the policy distribution service regarding the first serialized rule and the second serialized rule, and enabling the policy distribution service to retrieve the first serialized rule and the second serialized rule.

According to another aspect, embodiments relate to a system for generating a network policy. The system includes an interface for receiving a goal-based rule specifying a network policy that is to be enforced at each of a plurality of enforcement points; and one or more processors executing instructions stored on memory to: generate a first serialized rule based on the goal-based rule and a first enforcement point of the plurality of enforcement points, wherein the first serialized rule is in a first format interpretable by the first enforcement point; generate a second serialized rule based on the goal-based rule and a second enforcement point of the plurality of enforcement points, wherein the second serialized rule is in a second format interpretable by the second enforcement point; and communicate the first serialized rule and the second serialized rule to a policy distribution service, wherein the policy distribution service is configured to distribute the first serialized rule to the first enforcement point and distribute the second serialized rule to the second enforcement point.

In some embodiments, the goal-based rule is received as a text string specifying a desired outcome.

In some embodiments, the plurality of enforcement points include at least two of Domain Name Service (DNS) filtering stage, a firewall, or a Transport Layer Security (TLS) filtering stage, intrusion detection system (IDS), intrusion protection system (IPS), or web filtering.

In some embodiments, the goal-based rule includes a rank specifying its priority with respect to at least one other goal-based rule.

In some embodiments, the one or more processors are configured to convert the goal-based rule to the first serialized rule in a first format by executing a public application programming interface (API) to receive data regarding the goal-based rule, performing a semantic validation step and a syntactic validation step on the data regarding the goal-based rule, and executing a private API to communicate the first serialized rule to a policy aggregation service to enforce the first serialized rule at the first enforcement point.

In some embodiments, the first format interpretable by the first enforcement point is a REGO JavaScript Object Notation (JSON) string.

In some embodiments, the one or more processors are further configured to provide the first serialized rule to a cloud object storage location associated with the plurality of enforcement points, provide the second serialized rule to the cloud object storage location, and communicate the first serialized rule and the second serialized rule from the cloud object storage location to a policy distribution service to distribute the first serialized rule to the first enforcement point and the second serialized rule to the second enforcement point.

According to yet another aspect, embodiments relate to a computer program product for generating a network policy. The computer program product comprising computer executable code embodied in one or more non-transitory computer readable media that, when executing on one or more processors, performs the steps of receiving at an interface a goal-based rule specifying a network policy that is to be enforced at each of a plurality of enforcement points; generating a first serialized rule based on the goal-based rule and a first enforcement point of the plurality of enforcement points, wherein the first serialized rule is in a first format interpretable by the first enforcement point; generating a second serialized rule based on the goal-based rule and a second enforcement point of the plurality of enforcement points, wherein the second serialized rule is in a second format interpretable by the second enforcement point; enforcing the first serialized rule at the first enforcement point; and enforcing the second serialized rule at the second enforcement point.

In some embodiments, the plurality of enforcement points include at least one of Domain Name Service (DNS) filtering stage, a firewall, or a Transport Layer Security (TLS) filtering stage, intrusion detection system (IDS), intrusion protection system (IPS), or web filtering.

In some embodiments, the goal-based rule includes a rank specifying its priority with respect to at least one other goal-based rule.

In some embodiments, converting the goal-based rule into the first serialized rule includes executing a public application programming interface (API) to receive data regarding the goal-based rule, performing a semantic validation step and a syntactic validation step on the data regarding the goal-based rule, and executing a private API to communicate the first serialized rule to a policy aggregation service to enforce the first serialized rule at the first enforcement point.

In some embodiments, the first format interpretable by the first enforcement point is a REGO JavaScript Object Notation (JSON) string.

In some embodiments, the computer program product further includes computer executable code that, when executing on one or more processors, performs the steps of: providing the first serialized rule to a cloud object storage location associated with the plurality of enforcement points, providing the second serialized rule to the cloud object storage location, and communicating the first serialized rule and the second serialized rule from the cloud object storage location to a policy distribution service to enforce the first serialized rule at the first enforcement point and the second serialized rule at the second enforcement point.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A method for generating a network policy, the method comprising:
receiving at an interface a goal-based rule specifying a network policy that is to be enforced at each of a plurality of enforcement points;
communicating the goal-based rule to one or more processors executing instructions stored on memory to provide a rules service;
generating a first serialized rule based on the goal-based rule and a first enforcement point of the plurality of enforcement points, wherein the first serialized rule is in a first format interpretable by the first enforcement point;
generating a second serialized rule based on the goal-based rule and a second enforcement point of the plurality of enforcement points, wherein the second serialized rule is in a second format interpretable by the second enforcement point;
enforcing the first serialized rule at the first enforcement point; and
enforcing the second serialized rule at the second enforcement point.

2. The method of claim 1 wherein the plurality of enforcement points include at least one of Domain Name Service (DNS) filtering stage, a firewall, or a Transport Layer Security (TLS) filtering stage, intrusion detection system (IDS) intrusion protection system (IPS), IDS, or web filtering.

3. The method of claim 1 wherein the goal-based rule includes a rank specifying its priority with respect to at least one other goal-based rule.

4. The method of claim 1 wherein generating the goal-based rule into the first serialized rule includes in the first format includes:
executing a public application programming interface (API) to receive data regarding the goal-based rule,
performing a semantic validation step and a syntactic validation step on the data regarding the goal-based rule;
executing a private API to communicate the first serialized rule to a policy aggregation service to enforce the first serialized rule at the first enforcement point.

5. The method of claim 1 wherein the first format interpretable by the first enforcement point is a REGO JavaScript Object Notation (JSON) string.

6. The method of claim 1 further comprising:
providing the first serialized rule to a cloud object storage location associated with the plurality of enforcement points,
providing the second serialized rule to the cloud object storage location, and
communicating the first serialized rule and the second serialized rule from the cloud object storage location to a policy distribution service to:
distribute the first serialized rule to the first enforcement point, and
distribute the second serialized rule to the second enforcement point.

7. The method of claim 6 further comprising:
communicating a notification to the policy distribution service regarding the first serialized rule and the second serialized rule, and
enabling the policy distribution service to retrieve the first serialized rule and the second serialized rule.

8. A system for generating a network policy, the system comprising:
an interface for receiving a goal-based rule specifying a network policy that is to be enforced at each of a plurality of enforcement points; and
one or more processors executing instructions stored on memory to:
generate a first serialized rule based on the goal-based rule and a first enforcement point of the plurality of enforcement points, wherein the first serialized rule is in a first format interpretable by the first enforcement point,
generate a second serialized rule based on the goal-based rule and a second enforcement point of the plurality of enforcement points, wherein the second serialized rule is in a second format interpretable by the second enforcement point,
communicate the first serialized rule and the second serialized rule to a policy distribution service, wherein the policy distribution service is configured to distribute the first serialized rule to the first enforcement point and distribute the second serialized rule to the second enforcement point.

9. The system of claim 8 wherein the goal-based rule is received as a text string specifying a desired outcome.

10. The system of claim 8 the plurality of enforcement points include at least one of Domain Name Service (DNS) filtering stage, a firewall, or a Transport Layer Security (TLS) filtering stage, intrusion detection system (IDS), intrusion protection system (IPS), or web filtering.

11. The system of claim 8 wherein the goal-based rule includes a rank specifying its priority with respect to at least one other goal-based rule.

12. The system of claim 8 wherein the one or more processors are configured to convert the goal-based rule to the first serialized rule in a first format by:
executing a public application programming interface (API) to receive data regarding the goal-based rule,
performing a semantic validation step and a syntactic validation step on the data regarding the goal-based rule, and
executing a private API to communicate the first serialized rule to a policy aggregation service to enforce the first serialized rule at the first enforcement point.

13. The system of claim 8 wherein the first format interpretable by the first enforcement point is a REGO JavaScript Object Notation (JSON) string.

14. The system of claim 8 wherein the one or more processors are further configured to:
provide the first serialized rule to a cloud object storage location associated with the plurality of enforcement points,
provide the second serialized rule to the cloud object storage location, and
communicate the first serialized rule and the second serialized rule from the cloud object storage location to a policy distribution service to distribute the first serialized rule to the first enforcement point and the second serialized rule to the second enforcement point.

15. A computer program product for generating a network policy, the computer program product comprising computer executable code embodied in one or more non-transitory computer readable media that, when executing on one or more processors, performs the steps of:
receiving at an interface a goal-based rule specifying a network policy that is to be enforced at each of a plurality of enforcement points;
communicating the goal-based rule to one or more processors executing instructions stored on memory to provide a rules service;
generating a first serialized rule based on the goal-based rule and a first enforcement point of the plurality of enforcement points, wherein the first serialized rule is in a first format interpretable by the first enforcement point;
generating a second serialized rule based on the goal-based rule and a second enforcement point of the plurality of enforcement points, wherein the second serialized rule is in a second format interpretable by the second enforcement point;
enforcing the first serialized rule at the first enforcement point; and
enforcing the second serialized rule at the second enforcement point.

16. The computer program product of claim 15, wherein the plurality of enforcement points include at least one of Domain Name Service (DNS) filtering stage, a firewall, or a Transport Layer Security (TLS) filtering stage, intrusion detection system (IDS), intrusion protection system (IPS), or web filtering.

17. The computer program product of claim 15 wherein the goal-based rule includes a rank specifying its priority with respect to at least one other goal-based rule.

18. The computer program product of claim 15 wherein converting the goal-based rule into the first serialized rule includes:
executing a public application programming interface (API) to receive data regarding the goal-based rule,
performing a semantic validation step and a syntactic validation step on the data regarding the goal-based rule; and
executing a private API to communicate the first serialized rule to a policy aggregation service to enforce the first serialized rule at the first enforcement point.

19. The computer program product of claim 15, wherein the first format interpretable by the first enforcement point is a REGO JavaScript Object Notation (JSON) string.

20. The computer program product of claim 15, further comprising computer executable code that, when executing on one or more processors, performs the steps of:
providing the first serialized rule to a cloud object storage location associated with the plurality of enforcement points,
providing the second serialized rule to the cloud object storage location, and
communicating the first serialized rule and the second serialized rule from the cloud object storage location to a policy distribution service to enforce the first serialized rule at the first enforcement point and the second serialized rule at the second enforcement point.
